(19) United States
(12) Patent Application Publication
(10) Pub. No.: US 2015/0132601 A1
(43) Pub. Date: May 14, 2015

(54) SUPERALLOY MATERIAL DEPOSITION WITH INTERLAYER MATERIAL REMOVAL

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 14/075,587

(22) Filed: Nov. 8, 2013

(51) Int. Cl. B23K 25/00; B23K 26/00; B23K 20/24; B23K 26/34; B23P 6/04; B23K 31/02

(52) U.S. Cl. CPC B23K 25/005; B23P 6/04; B23K 31/02; B23K 20/24; B23K 26/345; B23K 26/0012; B23K 2201/00
USPC 428/615; 228/159; 420/591; 228/119; 219/76.14; 219/73.21

(57) ABSTRACT

A method of depositing a multi-layer cladding (40) of superalloy material and an apparatus so formed. A first layer of material (20) is deposited on a substrate (22) such as by laser cladding of superalloy powder (54). The deposited material includes a directionally solidified region (24) and a topmost equiaxed region (26). The topmost region is removed such as by grinding to expose a flat surface (28) of directionally solidified material. A second layer of material (32) deposited onto the exposed flat surface will again have a directionally solidified region (34) and a topmost equiaxed region (36). The process is repeated until a desired thickness of cladding material is achieved, the multi-layer cladding having no equiaxed material between its layers throughout its thickness.

### FIELD OF THE INVENTION

This invention relates generally to the field of materials technology, and more specifically to a method of depositing superalloy materials without cracking.

### BACKGROUND OF THE INVENTION

Welding processes vary considerably depending upon the type of material being welded. Some materials are more easily welded under a variety of conditions, while other materials require special processes in order to achieve a structurally sound joint without degrading the surrounding substrate material.

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair, and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

FIG. 1 is a conventional chart illustrating the relative weldability of various alloys as a function of their aluminum and titanium content. Alloys such as Inconel® IN718 which have relatively lower concentrations of these elements, and consequentially relatively lower gamma prime content, are considered relatively weldable, although such welding is generally limited to low stress regions of a component. Alloys such as Inconel® IN939 which have relatively higher concentrations of these elements are generally not considered to be weldable, or can be welded only with the special procedures discussed above which increase the temperature/ductility of the material and which minimize the heat input of the process. A dashed line 10 indicates a recognized upper boundary of a zone of weldability. The line 10 intersects 3 wt. % aluminum on the vertical axis and 6 wt. % titanium on the horizontal axis. Alloys outside the zone of weldability are recognized as being very difficult or impossible to weld with known processes, and the alloys with the highest aluminum content are generally found to be the most difficult to weld, as indicated by the arrow.

It is also known to utilize selective laser melting (SLM) or selective laser sintering (SLS) to melt a thin layer of superalloy powder particles onto a superalloy substrate. The melt pool is shielded from the atmosphere by applying an inert gas, such as argon, during the laser heating. These processes tend to trap the oxides (e.g. aluminum and chromium oxides) that are adherent on the surface of the particles within the layer of deposited material, resulting in porosity, inclusions and other defects associated with the trapped oxides. Post process hot isostatic pressing (HIP) is often used to collapse these voids, inclusions and cracks in order to improve the properties of the deposited coating. Laser microcladding of very thin layers of superalloy materials (i.e. fractions of a mm) has been accomplished with some success. However, such processes are slow and therefore costly, and the deposition of superalloys in the zone of non-weldability remains problematic.

### BRIEF DESCRIPTION OF THE DRAWINGS

The invention is explained in the following description in view of the drawings that show:

FIG. 1 is a conventional chart illustrating the relative weldability of various alloys as a function of their aluminum and titanium content

FIG. 2 is a sectional view of a prior art deposit of material.

FIGS. 3A-3D illustrate steps in a process according to the present invention.

FIG. 4 illustrates a step in an embodiment of the present invention.

FIG. 5 is a flow chart of a component repair process of the present invention.

### DETAILED DESCRIPTION OF THE INVENTION

The present inventors have developed a technique that enables the successful deposition of very difficult to weld superalloy materials in layer thicknesses that far exceed those achieved in the prior art, with the deposited material further having an advantageous directionally-solidified crystal structure. The present inventors have recognized certain characteristics of clad materials, and they have developed the present invention to exploit the beneficial aspects of those characteristics and to overcome the detrimental aspects of those characteristics.

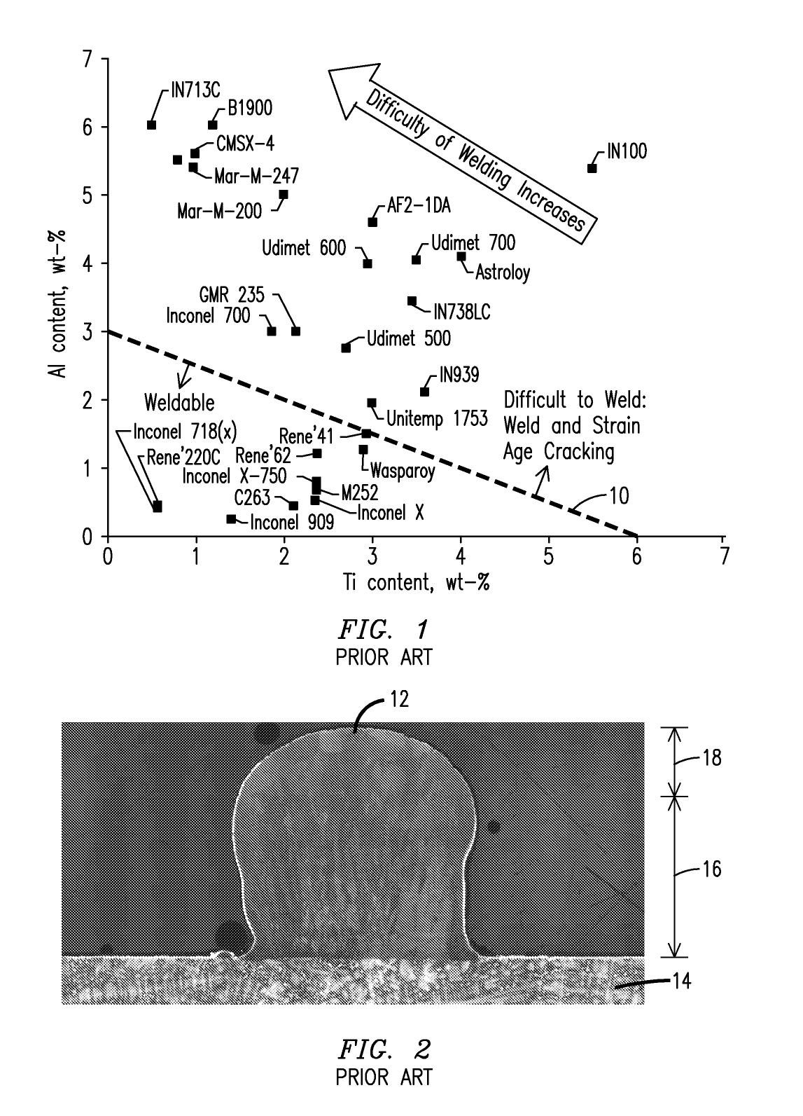

FIG. 2 is a cross sectional view of a layer of material 12 deposited by a laser cladding process onto a polycrystalline equiaxed substrate 14. Broad area laser cladding over a generally flat surface tends to produce a temperature gradient in the deposited material that is roughly perpendicular to the surface. For modest deposition travel speeds, the temperature gradient is only slightly skewed from normal in the direction of travel progression. Epitaxial solidification occurs along such a temperature gradient as the deposited material cools primarily by heat loss to the underlying substrate. Thus the microstructure tends to be directionally solidified with the grains growing approximately perpendicular to the substrate surface. This effect is akin to a directionally solidified casting process wherein the casting mold provides walls with relatively low heat transfer and heat is extracted from the bottom of the mold to cause the material grains to grow vertically. This effect is revealed in the generally vertically oriented grains of region 16 of FIG. 2.

The top region 18 of the deposited material 12 has a somewhat rounded shape caused by surface tension effects. While heat loss to the surrounding atmosphere is relatively low compared to the heat loss to the substrate, there will exist a temperature gradient over the top region 18 that is roughly perpendicular to this rounded contour. Unidirectional solidification is therefore lost in this region, and the grain structure is typically equiaxed, as seen in FIG. 2. The deposition of a second layer of material (not shown) over this first deposit 12 would tend to produce more equiaxed material because the temperature gradient would then be perpendicular to a rounded surface.

For difficult to weld superalloy materials, the onset of equiaxed solidification is often associated with microcracking. The inventors have found that cladding formed by a plurality of layers of deposited material can be free of cracks proximate the substrate, yet exhibit a deleterious multitude of cracks in subsequent layers. The reasons for such cracking may include the fact that equiaxed material has more potentially weakened grain boundary area, as well as the possibility that stresses may be unfavorably oriented during solidification and deposit shrinkage.

The present inventors have found that by incorporating an interlayer material removal step in a multi-layer cladding process, crack free deposits of even hard to weld superalloy materials can be achieved. In particular, after depositing a layer of material onto a substrate surface, an equiaxed material portion of the layer of material is removed to expose a surface of directionally solidified material. The material removal process may be by grinding, machining, or any other process effective to remove an upper equiaxed region of a layer of deposited material, such as layer 18 of deposit 12. The exposed surface of directionally solidified material is then preferably parallel to the original substrate surface and perpendicular to the direction of grain growth, and it is ready to be clad with another layer of material. The material removal and depositing steps are then repeated to until a desired thickness of directionally solidified material is obtained.

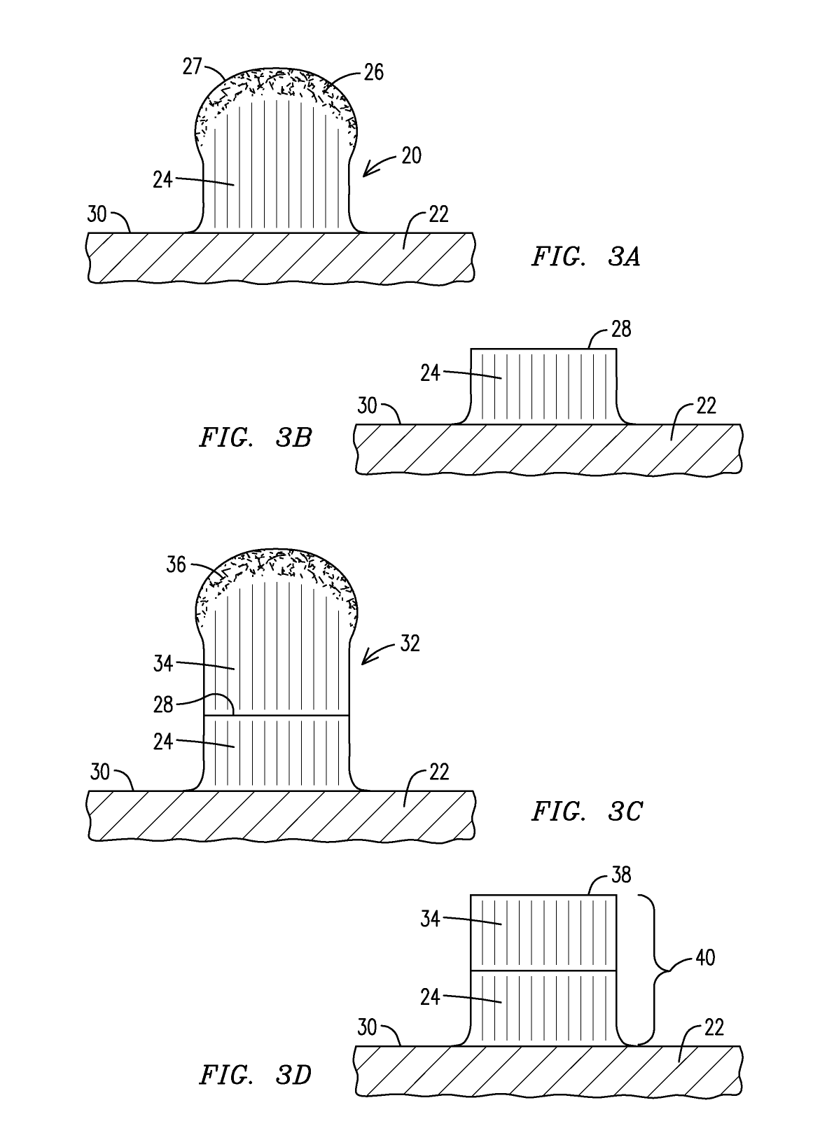

One such process is described in more detail with reference made to FIGS. 3A-3D. FIG. 3A is a cross-sectional view of a first layer of alloy material 20 deposited on a substrate 22, such as by a laser cladding process. The alloy material 20 and substrate 22 may be superalloy materials in some embodiments. The alloy material 20 includes a directionally solidified region 24 and an equiaxed region 26. The names of these regions as used herein are not intended to preclude some incidental amount of other crystal types in a region, but rather, to indicate the predominant crystallographic morphology in a region. The equiaxed region 26 has an upper surface 27 that is not parallel to the surface 30 of the substrate 22 due to the normal surface tension effects.

FIG. 3B illustrates the structure of FIG. 3A after it has undergone a material removal process where the equiaxed region 24 has been removed to expose a surface 28 of the directionally solidified material 24. The exposed surface 28 is preferably flat, parallel to the original surface 30 of substrate 22, and perpendicular to the longitudinal growth axis of the directionally solidified material 24. Some directionally solidified material may be removed during the material removal step.

FIG. 3C illustrates the structure of FIG. 3B after a second layer of alloy material 32 has been deposited onto the directionally solidified surface 28. The second layer 32 also includes a directionally solidified region 34 and an overlying equiaxed region 36. The relatively flat directionally solidified surface 28 provides the heat sink for creating the temperature gradient necessary to grow the directionally solidified region 34 during the material deposition process. No equiaxed material remains between the layers of directionally solidified material 24, 34, and directional solidification is thus extended from layer to layer. In one test sample having four layers, a directionally solidified microstructure was extended to nearly the top of the fourth layer without cracking with light grinding (less than about 1 mm material removal) between layers. Similar grinding may be of value in multi-pass side-by-side laser cladding of superalloys.

FIG. 3D illustrates the structure of FIG. 3C after the equiaxed region 36 has been removed to expose another flat directionally solidified surface 38 which is available for further deposition of material as necessary to achieve a multi-layer cladding 40 having a desired thickness. Unlike prior art multi-layer claddings of superalloy material, the cladding 40 in accordance with the present invention includes no equiaxed material through a thickness thereof. When substrate surface 30 is planar or at least reasonably flat in the region of material deposition, it is possible to produce a cladding 40 of directionally solidified material on the substrate 22 whether the substrate 22 is directionally solidified or equiaxed.

Optionally, the direction of clad progression between layers may be varied as further assistance in preserving directional solidification. With slow travel speeds, the temperature gradient is only slightly skewed from normal in the direction of travel, thereby resulting in a small degree of non-perpendicularity between the longitudinal axis of grain growth and the plane of the substrate surface. Additional layers deposited in the same travel direction may cause progressive skewing that could ultimately lead to equiaxed solidification. By reversing direction of progression (i.e. first into the plane of FIG. 3, then out of the plane of FIG. 3) the skewed temperature gradient would alternate between layers and thereby maintain solidification in the vertical direction. The direction of deposition may be reversed between each layer, or some plurality of layers may be deposited between reversals in various embodiments.

FIG. 4 illustrates a material deposition process that may be used to deposit a superalloy material (such as layer 20 of FIG. 3A or layer 34 of FIG. 3C) in accordance with an embodiment of the invention. In FIG. 4, a substrate 50 is undergoing a flux-assisted laser cladding process. Substrate 50 is covered by a layer of powder 52 including a layer of alloy powder 54 and an overlying layer of flux material 56. In other embodiments the alloy powder and flux powder may be mixed together before being deposited on the substrate. An energy beam such as laser beam 58 is traversed relative to the substrate 50 to form a moving melt pool 60. The melt pool 60 re-solidifies to form cladding 62 covered by a layer of slag 64. As described more fully in the inventors' co-pending United States Patent Application Publication US 2013/0140278 A1, attorney docket 2012P22347US, incorporated by reference herein, the flux material 56 and resultant layer of slag 64 provide a number of functions that are beneficial for preventing cracking of the cladding 62 and the underlying substrate material 50. First, they function to shield both the region of molten material and the solidified (but still hot) cladding material 62 from the atmosphere in the region downstream of the laser beam 58. The slag floats to the surface to separate the molten or hot metal from the atmosphere, and the flux may be formulated to produce a shielding gas in some embodiments, thereby avoiding or minimizing the use of expensive inert gas. Second, the slag 64 acts as a blanket that allows the solidified material to cool slowly and evenly, thereby reducing residual stresses that can contribute to post weld reheat or strain age cracking. The insulating effect of the slag 64 also tends to reduce the volume of equiaxed material freezing on the top of the solidifying weld pool 60 by reducing the heat loss to the atmosphere relative to the heat loss to the substrate 50. Third, the slag 64 helps to shape the pool of molten metal. Fourth, the flux material 56 provides a cleansing effect for removing trace impurities, such as sulfur and phosphorous, which contribute to weld solidification cracking. Such cleansing includes de-oxidation of the metal powder. Finally, the flux material 56 may provide energy absorption and trapping functions to more effectively convert the laser beam 58 into heat energy, thus facilitating a precise control of heat input and a resultant tight control of material temperature during the process. Additionally, the flux may be formulated to compensate for loss of volatized elements during processing or to actively contribute elements to the deposit that are not otherwise provided by the metal powder itself. This process can produce crack-free deposits of superalloy cladding of more than 2 mm thickness (e.g. up to 4 mm or 6 mm) on superalloy substrates at room temperature for materials that heretofore were believed only to be joinable with a hot box process or through the use of a chill plate, including those materials with compositions that lie above line 10 in FIG. 1. This is in contrast to prior SLM processes that typically deposit layers of up to only 200 microns, for example. The layer of slag 64 is then removed prior to or during the material removal step described with respect to FIGS. 3B and 3D. As described above, the as-deposited cladding material 62 will include a directionally solidified region covered by an equiaxed region. While much greater layer thicknesses are achievable with this process, in one embodiment the powdered alloy material 54 is deposited to have a thickness sufficient so that the as-deposited layer of superalloy cladding 62 has a thickness of greater than 2 mm, and at least 1 mm of that thickness is removed to expose a surface of directionally solidified superalloy material of at least 1 mm thickness.

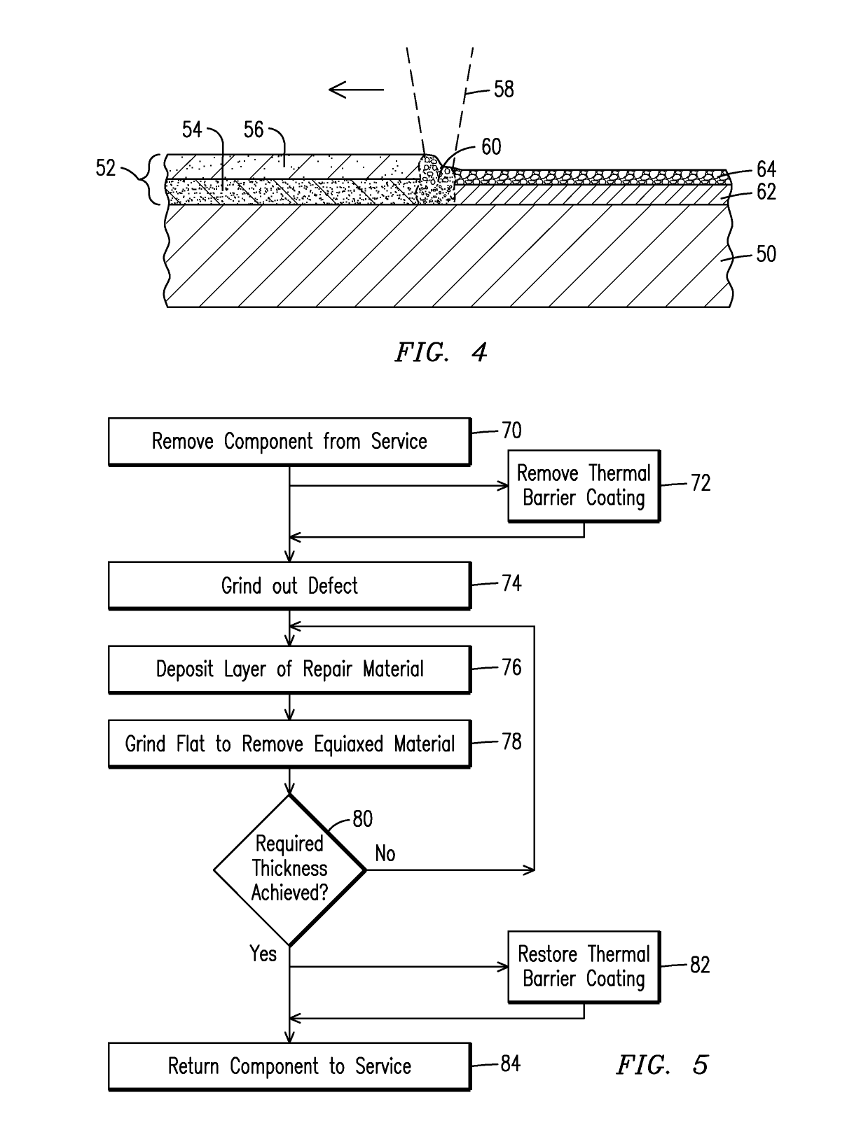

The process described here may have application to the repair of superalloy components used in gas turbine engines, such as blades and vanes. FIG. 5 illustrates steps in a method for repairing such components. A gas turbine engine is removed from service and a hot gas path component of the engine is removed from the engine for repair at step 70. If the component includes a ceramic thermal barrier coating, a portion of the coating may be removed in a region to be repaired at step 72. Upon inspection, a defect in the repair region is removed, such as by grinding or machining at step 74, with post-machining inspection to confirm defect removal. The grinding or machining may preferably form a planar surface, or a generally flat surface having curvature that is sufficiently low so that directional solidification proceeding from that surface will develop primarily columnar grained material. A layer of superalloy repair material is then deposited at step 76, such as with a laser cladding process. Such a process will produce a layer of clad material having a directionally solidified region proximate the flat surface and a topmost region of equiaxed material. The layer of repair material is then ground flat at step 78 to remove the equiaxed material and to restore a planar or generally flat surface. If additional thickness of material is needed at step 80, steps 76 and 78 are repeated until a desired thickness of directionally solidified superalloy repair material is obtained. The thermal barrier coating is then restored at step 82, if appropriate, and the component is then returned to service in a gas turbine engine at step 84.

An apparatus formed or repaired in accordance with the invention may include a substrate; a superalloy material cladding on a surface of the substrate including a plurality of layers of directionally solidified superalloy material, grains of the directionally solidified superalloy material extending in a thickness direction perpendicular to the surface of the substrate; and the cladding having no equiaxed or non-directional polycrystalline superalloy material disposed between the layers in the thickness direction. The substrate may be a directionally solidified or equiaxed material. The cladding and/or the substrate may have a composition lying beyond the zone of weldability defined in FIG. 1.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
depositing a layer of material onto a substrate surface; and
removing an equiaxed material portion of the layer of material to expose a surface of directionally solidified material.

2. The method of claim 1, further comprising:
depositing a second layer of material onto the surface of directionally solidified material; and
removing an equiaxed material portion of the second layer of material to expose a second surface of directionally solidified material; and
reversing a direction of deposition between the two layers.

3. The method of claim 1, further comprising:
depositing a layer of powdered material comprising a superalloy material and a flux material onto the substrate surface;
melting at least a portion of the layer of powdered material to form the layer of superalloy material on the substrate surface covered by a layer of slag; and
removing the slag and the equiaxed material portion to expose the surface of directionally solidified superalloy material.

4. The method of claim 3, further comprising:
depositing the layer of powdered material to have a thickness sufficient so that the layer of superalloy material has a thickness of greater than 2 mm; and
removing a top portion of at least 1 mm thickness of the layer of superalloy material to expose the surface of directionally solidified superalloy material.

5. The method of claim 3, wherein the deposited layer of superalloy material has a top surface that is not parallel to the substrate surface; and
wherein the step of removing an equiaxed material portion of the layer of superalloy material forms the surface of directionally solidified superalloy material to be parallel to the substrate surface.

6. The method of claim 3, wherein the superalloy material lies beyond a zone of weldability defined on a graph of superalloys plotting titanium content verses aluminum content, wherein the zone of weldability is upper bounded by a line intersecting the titanium content axis at 6 wt. % and intersecting the aluminum content axis at 3 wt. %.

7. A cladding of superalloy material deposited on a substrate by the method of claim 1.

8. A component comprising a plurality of layers of superalloy material deposited on a substrate by the method of claim 2 and comprising no equiaxed material through a thickness of the plurality of layers.

9. A method comprising:
depositing particles of a superalloy material onto a substrate surface;
melting the particles with an energy beam to form a melt pool;
allowing the melt pool to cool and to directionally grow grains of the superalloy material in a direction perpendicular to the substrate surface; and
removing equiaxed superalloy material formed above the directionally solidified grains remote from the substrate surface to expose a cladding surface of directionally solidified superalloy material.

10. The method of claim 9, further comprising:
depositing particles of a flux material with the particles of the superalloy material onto the substrate surface;
melting the particles of flux with the particles of superalloy material to form a layer of slag on the melt pool;
allowing the melt pool to cool and to solidify under the slag; and
removing the slag and the equiaxed superalloy material to expose the cladding surface of directionally solidified superalloy material.

11. The method of claim 10, further comprising:
grinding or machining the solidified material to form the cladding surface to be parallel to the substrate surface; and
repeating the method until a desired thickness of directionally solidified superalloy material is on the substrate surface.

12. The method of claim 11, further comprising reversing a direction of deposition between at least two of the depositing steps.

13. The method of claim 10, wherein the superalloy material lies beyond a zone of weldability defined on a graph of superalloys plotting titanium content verses aluminum content, wherein the zone of weldability is upper bounded by a line intersecting the titanium content axis at 6 wt. % and intersecting the aluminum content axis at 3 wt. %.

14. A cladding of superalloy material deposited on a substrate by the method of claim 9.

15. A component comprising a plurality of layers of superalloy material deposited on a substrate by the method of claim 11 and comprising no equiaxed material through a thickness of the plurality of layers.

16. A method comprising:
removing a degraded portion of a superalloy substrate in a repair region;
depositing a first layer of superalloy cladding material in the repair region;
removing a topmost portion of the first layer to expose a directionally solidified surface of the superalloy cladding material; and
depositing a second layer of superalloy cladding material onto the directionally solidified surface.

17. The method of claim 16, further comprising melting a layer of powder comprising superalloy particles and flux particles with an energy beam to accomplish each of the depositing steps.

18. The method of claim 16, further comprising:
removing the degraded portion by grinding the substrate to form a first generally flat surface; and
removing the topmost portion by grinding to form the directionally solidified surface to be a second generally flat surface parallel to the first generally flat surface.

19. The method of claim 16, further comprising depositing the second layer with a direction of deposition reversed from a direction of deposition of the first layer.

20. An apparatus repaired by the method of claim 16 and comprising no equiaxed material between the first and second layers.
